(19) United States
(12) Patent Application Publication
(10) Pub. No.: US 2004/0225830 A1
(43) Pub. Date: Nov. 11, 2004

(54) Apparatus and methods for linking a processor and cache

(76) Inventor: Eric DeLano, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/430,557

(22) Filed: May 6, 2003

(51) Int. Cl. G06F 12/00

(52) U.S. Cl. 711/105

(57) ABSTRACT

A processing system includes a processor on a die, a cache memory external to the die, and a high-bandwidth interconnection between the processor and the cache memory. Where the cache is dynamic random access memory (DRAM), shorter latencies are generated than in traditional DRAM cache/processor configurations, yet higher density can be provided than available using SRAM caches.

### FIELD OF THE INVENTION

The present invention relates generally to processing systems and, more particularly, to linking a processor with a cache external to the processor.

### BACKGROUND OF THE INVENTION

It is widely known that the performance of processors and processing systems can be enhanced through the use of large caches to hold lines of data retrieved from memory. It can be advantageous to fabricate a high-bandwidth cache on the same die as a processor, because it can be less expensive to add wires on a processor die than to provide an off-die cache. Large on-die caches, however, tend to occupy a lot of silicon area on the die. Silicon area is a precious resource, and it can be preferable to reserve it for other and additional functional units such as adders and multipliers.

In a multi-chip processing environment, off-die caches are advantageous in that they can be very large, particularly if DRAM (dynamic random access memory) technology is utilized. DRAM is much denser than typical SRAM (static random access memory), and so DRAM caches can be very large compared to SRAM caches. DRAM caches also typically use less power per megabyte than SRAM caches. A disadvantage of using off-chip caches, however, lies in the fact that it can be very expensive to provide a large amount of bandwidth between the cache and the processor. It can be expensive because the connecting wires have to be routed not just on the processor die, but also on the circuit board. It would be desirable to provide a cache having high density, large bandwidth and better latency than is currently available using currently available off-die cache.

### SUMMARY OF THE INVENTION

In one embodiment, the invention is directed to a processing system including a processor on a die, a cache memory external to the die, and a high-bandwidth interconnection between the processor and the cache memory.

Further areas of applicability of the present invention will become apparent from the detailed description provided hereinafter. It should be understood that the detailed description and specific examples, while indicating embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram of a conventional processing system; and

FIG. 2 is a diagram of a multi-chip module according to one embodiment of the present invention.

### DETAILED DESCRIPTION OF THE INVENTION

The following description of embodiments of the present invention is merely exemplary in nature and is in no way intended to limit the invention, its application, or uses. Although embodiments of the present invention are described herein in connection with a multi-chip module (MCM), the invention is not so limited and can be practiced in connection with other kinds of processing systems.

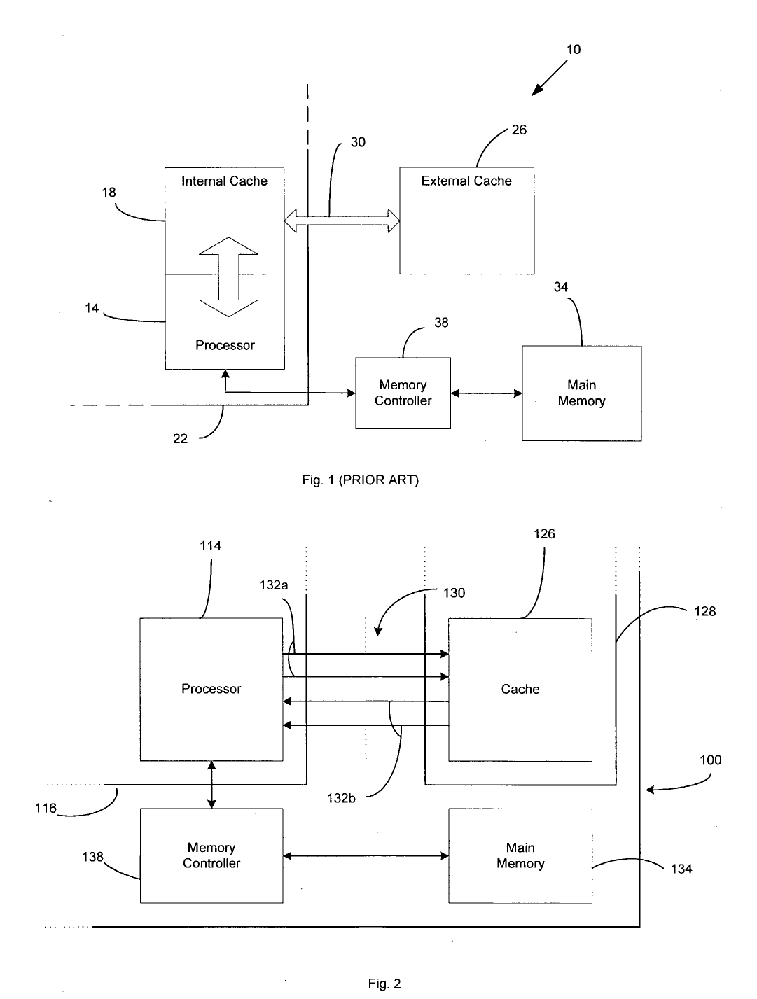

A simplified conventional processing system is generally indicated in FIG. 1 by reference number 10. A processor 14 has a small (for example, a 1- to 4-megabyte) internal primary cache 18 that runs at the same speed as the processor 14 (e.g., between 0.5 and 1 gigahertz). Bandwidths between the processor 14 and cache 18 typically are between about 8 and 16 gigabytes per second. Thus the processor 14 and cache 18 have a high degree of bandwidth available for communicating with each other. The processor 14 and its internal cache are provided on a die 22.

Although it might be desirable to provide an upper-level cache on the same die as the processor 14 and that operates at the same speed as the primary cache 18, area on the die 22 generally is expensive and thus typically is utilized for other system components. Thus the processor 14 utilizes an external, off-chip upper-level cache 26 that is larger but operates more slowly than the processor 14 and primary cache 18. A low-bandwidth connection 30 connects the processor 14 and the external cache 26. Bandwidth between the processor 14 and the cache 26 is, for example, about 6.4 gigabytes per second (for about 200 megahertz DDR (double data rate), or about 400 mega-transfers per second, and a width of 16 bytes). The caches 18 and 26 hold lines of data retrieved from a main memory 34, via a memory controller 38, for use by the processor 14 as known in the art.

A multi-chip module (MCM) according to one embodiment of the present invention is indicated generally in FIG. 2 by reference number 100. A processor 114 is provided on a chip or die 116 of the MCM 100 and has, for example, an internal primary cache (not shown). A cache 126 is provided on a chip or die 128 of the MCM 100. The cache 126 is fabricated, for example, of DRAM.

The cache 126 and the processor 114 are connected via a high-bandwidth interconnection, e.g., a link interconnection, indicated generally by reference number 130. The interconnection 130 can provide a bandwidth of up to about four (4) giga-transfers per second. The interconnection 130 includes, for example, a point-to-point differential signal interconnection in which one or more unidirectional differential signal pairs 132a are configured to transmit logical bits from the processor 114 to the cache 126 and one or more unidirectional differential signal pairs 132b are configured to transmit logical bits from the cache 126 to the processor 114. The interconnection 130 has, for example, sixteen signal pairs 132a (one of which is shown in FIG. 2) and sixteen signal pairs 132b (one of which is shown in FIG. 2). Thus the interconnection 130 can provide a transfer rate of about 8 gigabytes per second per direction, for a total bandwidth of about 16 gigabytes per second between the processor 114 and the cache 126. The data lines 132a and 132b can be clocked using, for example, source-synchronous or embedded clocking.

In other embodiments, other signal types and/or numbers of signal pairs can be used. Various types of high-bandwidth interconnections also could be used. Embodiments are contemplated, for example, wherein the interconnection 130 is a high-speed link such as a SerDes (serializer/deserializer) link.

The processor 114 is connected with a memory 134 via a memory controller 138. At least a part of the memory 134 is mapped onto the cache memory 126. When the processor 114 calls for data from the memory 134, the data can be written into the cache memory 126. The processor then can access the data in the cache 126 via the interconnection 130.

The interconnection 130 allows valuable processing system transistor density to be utilized so as to improve performance, reliability, availability and serviceability. Valuable room on the processor chip can be made available when it is no longer necessary to provide a large on-die cache. DRAM caches configured with processors in accordance with embodiments of the present invention can have shorter latencies than traditional DRAM cache/processor configurations yet can provide higher densities than available using SRAM caches.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A processing system comprising a processor on a die, a cache memory external to the die, and a high-bandwidth interconnection between the processor and the cache memory.

2. The processing system of claim 1 wherein the cache memory comprises dynamic random access memory.

3. The processing system of claim 1 wherein the high-bandwidth interconnection comprises a point-to-point differential signal connection.

4. The processing system of claim 3 wherein the high-bandwidth interconnection further comprises a plurality of differential signal pairs.

5. The processing system of claim 4 wherein the plurality comprises thirty-two differential signal pairs.

6. The processing system of claim 1 wherein the high-bandwidth interconnection comprises a plurality of unidirectional signal connections.

7. The processing system of claim 1 wherein the high-bandwidth interconnection comprises a transfer rate of up to about four giga-transfers per second.

8. The processing system of claim 1 wherein the high-bandwidth interconnection comprises a serializer/deserializer link.

9. A processing system comprising a processor, a cache memory comprising dynamic random access memory, and a link interconnection between the processor and the cache memory.

10. The processing system of claim 9 further comprising a die on which the processor is located, and wherein the cache memory is external to the die.

11. The processing system of claim 9 wherein the link interconnection comprises a point-to-point differential signal connection.

12. The processing system of claim 11 wherein the link interconnection further comprises sixteen differential signal pairs per direction.

13. A method for processing data located in a main memory using a processor configured to access the main memory, the method comprising:
providing a cache memory external to the processor;
writing data from the main memory to the cache memory; and
the processor accessing the cache memory using a high-bandwidth interconnection between the processor and the cache memory.

14. The method of claim 13 further comprising transferring data between the processor and the cache memory using a point-to-point differential signal.

15. The method of claim 13 wherein providing a cache memory comprises configuring the cache memory and the processor on different dies.

16. The method of claim 13 further comprising the processor accessing the data in the cache memory using dynamic random access.

17. The method of claim 13 wherein the processor accessing the cache memory is performed at up to about four giga-transfers per second.

18. A multi-chip module comprising a processor on a first chip, a cache memory on a second chip, and a link interconnection between the first and second chips.

19. The multi-chip module of claim 18 wherein the link interconnection connects the processor and the cache memory.

20. The multi-chip module of claim 18 wherein the second chip comprises dynamic random access memory.

21. The multi-chip module of claim 18 wherein the link interconnection comprises a plurality of unidirectional signal connections.

22. A cache memory adaptable for use with a processor on a die separate from the cache, comprising:
a dynamic random access memory; and
a high-bandwidth interconnection connected with the memory and configured for connection with the processor.

23. The cache memory of claim 22, wherein the high-bandwidth interconnection comprises a serializer/deserializer interconnection.

24. The cache memory of claim 22, wherein the high-bandwidth interconnection comprises a point-to-point interconnection.

25. The cache memory of claim 22, wherein high-bandwidth comprises up to about four giga-transfers per second.

26. A method of fabricating a processing system comprising:
providing a processor on a die;
providing a dynamic random access cache memory on another die; and
connecting the processor and the cache memory using a high-bandwidth interconnection.
